(19) United States
(12) Patent Application Publication
(10) Pub. No.: US 2011/0105126 A1
(43) Pub. Date: May 5, 2011

(54) Terminal initiated intrasatellite antenna handover method

(75) Inventors: Robert M. Liang, Irvine, CA (US); Joseph Han, Irvine, CA (US); Milton K. Sue, San Gabriel, CA (US); Gary Y. Guo, Irvine, CA (US)

(73) Assignee: The Aerospace Corportion

(21) Appl. No.: 12/456,286

(22) Filed: Jun. 15, 2009

(51) Int. Cl. H04W 36/36

(52) U.S. Cl. 455/437

(57) ABSTRACT

A handover method provides intrasatellite transmitter handover detection and decision using an unbiased weighted Signal Noise Ratio (SNR) estimator based on forgetting factors for SNR monitoring, and a threshold delay is introduced to ensure the reliability of handover decision to prevent undesirable handovers during beam switching.

### STATEMENT OF GOVERNMENT INTEREST

The invention was made with Government support under contract No. FA8802-04-C-0001 by the Department of the Air Force. The Government has certain rights in the invention.

### FIELD OF THE INVENTION

The invention relates to the field of satellite and terminal communications. More particularly, the present invention relates to a method of handing off communications between satellites through terminal initiation.

### BACKGROUND OF THE INVENTION

Future communication networks are rapidly evolving the capability to offer multiple priorities and different grades of internet provider based services to a dynamic spatial and temporal composition of heterogeneous traffic users. In order to provide complete coverage to a diverse users, satellites will play an integral part of future communication infrastructures. Some communication systems provide authorized users with a seamless and secure communication environment to meet the needs of various dispersed users. Network centric technologies are essential for managing and allocating valuable communication network resources efficiently to provide the end-to-end quality of service. The Transformational Satellite Communications System (TSAT) requires network-centric capabilities, scalability, and interoperability. To achieve various objectives, TSAT has adapted internet-like transport architecture amongst widely deployed fixed and mobile nodes that communicate over satellite networks. Such services, however, can only become feasible when the TSAT has sufficiently large system capacity and resources. Furthermore, future satellite systems are intended to complement and extend the existing terrestrial networks to provide beyond line-of-sight communications to achieve complete global coverage. Thus, the trend in future communication satellite systems will offer fast and integrated service to ubiquitous mobile terminals on demand.

Intrasatellite handover is an essential procedure required for providing seamless communications for various mobile terminals with high data rate, such as communications with mobile terminals, aircraft, and ships as mobile terminals travel from one antenna coverage to another or from one spot beam to another. A basic cellular system consists of mobile stations, base stations, and a mobile switch center. The mobile switch center is responsible for connecting all mobile terminals to the public switched telephone network. Each mobile terminal communicates using radio with one of the base stations and may be handed off to any other base stations throughout the duration of a call. Typical handover strategy used in the cellular network is the base station initiated handover decision with mobile assistance. In this case, every mobile terminal measures the received power from the surrounding base states and continuously reports these measurements back to the serving base station. The serving base station makes the handover decisions. Thus, this handover procedure is known as mobile assisted handoff. The mobile assisted handoff may not be suitable for future satellite networks because of the extra processing power required to process the handover decision algorithm for a large number of mobile terminals. Due to the power and weight limitations on the satellite, existing satellite systems may not be able to serve a growing amount of handover decisions for reliable communications with an ever growing number of mobile terminals. These and other disadvantages are solved or reduced by using the invention.

### SUMMARY OF THE INVENTION

An object of the invention is to provide a method of mobile terminal initiated handover between communication service transmitters having respective communications coverage beams.

Another object of the invention is to provide a method of mobile terminal initiated handover from a current service transmitter to an adjacent service transmitter by detecting signal to noise ratios (SNRs) of signals from the current service transmitter having a current coverage beam and adjacent service transmitters having adjacent coverage beams.

Yet another object of the invention is to provide a method of mobile terminal initiated handover from a current service transmitter to an adjacent service transmitter by detecting SNRs of signals from the current and adjacent service transmitters and initiating handover to a selected one of the adjacent service transmitters.

Still another object of the invention is to provide a method of mobile terminal initiated handover from a current service transmitter to one of a plurality of adjacent service transmitters by detecting SNRs of signals from the current and adjacent service transmitters and initiating handover to a selected one of the adjacent service transmitters based upon a threshold value.

Still a further object of the invention is to provide a method of mobile terminal initiated handover from a current service transmitter to an adjacent service transmitter by detecting and filtering SNRs into filtered estimates of the current and adjacent transmitters and initiating handover to a selected service transmitter selected from the adjacent transmitters when a maximum difference between the filtered estimate of the current coverage beam and the selected one of the filtered estimates of the selected service cover beam exceeds a threshold value for establishing communications between the mobile terminal and the selected service transmitter.

Still a further object of the invention is to provide a method of mobile terminal initiated handover from a current service transmitter to an adjacent service transmitter by monitoring SNRs from current and adjacent transmitters and by requesting and receiving link data from the current service transmitter for establishing communications with a selected service transmitter being among the adjacent service transmitters.

The present invention is directed to a terminal initiated handover method. The terminal initiated handover method is different than the traditional cellular handover processes by using the distributive processing capabilities of mobile terminals to initiate the handover process. The handover method measures signal to noise ratio (SNRs) of a current service transmitter having a current coverage beam with SNRs of various adjacent service and adjacent coverage beams are detected and respective SNRs are measured and filtered into filtered estimates. The filtered estimates are compared to each other and to a predetermined threshold value. When the difference between the SNR filtered estimate of the current coverage beam minus the highest SNR filtered estimate of one of the adjacent coverage beams is greater than a predetermined value, the mobile terminal initiates handover from the current service transmitter to a selected one of the adjacent service transmitters having that highest SNR filtered estimate. This determination can be repeated by probe cycles as part of the handover method.

When handover initiation has been determined, the mobile terminal requests and receives link data of a selected service transmitter from the current service transmitter for handover to the selected service transmitter. The communication between the current service transmitters is then terminated. The mobile terminal then sends link data parameters to the selected service transmitter for establishing communication between the mobile terminal and the selected service transmitters. In this manner, the mobile terminal monitors coverage beams, determines when handover should occur, and establishes communication with the selected one of the adjacent service transmitters, thereby distributing the handover process to the mobile terminal. These and other advantages will become more apparent from the following detailed description of the preferred embodiment.

### BRIEF DESCRIPTION OF THE DRAWINGS

FIG. 1 is a flow chart of a terminal initiated handover method.

FIG. 2 is a terminal initiated handover timing diagram.

### DETAILED DESCRIPTION OF THE PREFERRED EMBODIMENT

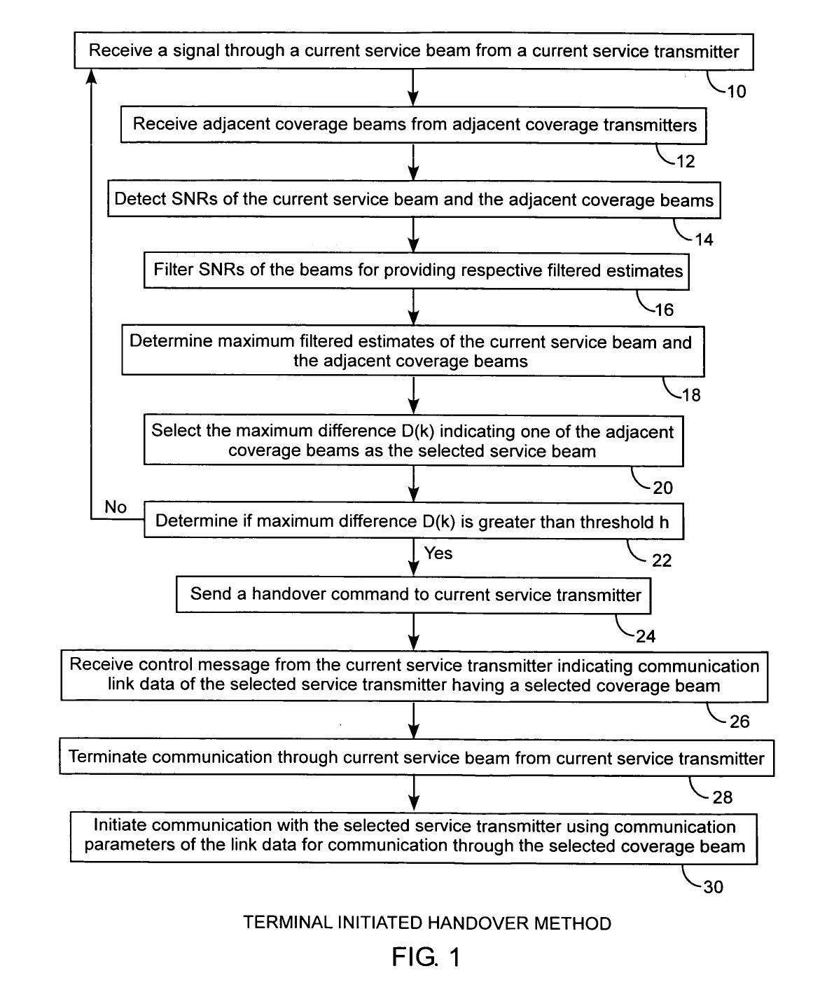

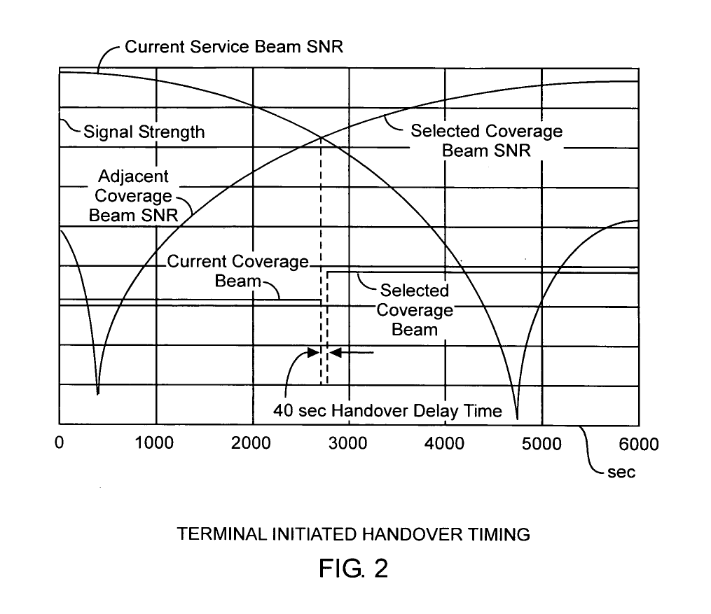

An embodiment of the invention is described with reference to the figures using reference designations as shown in the figures. Referring to FIGS. 1 and 2, a terminal initiated handover method starts with a mobile terminal being in communication with a current service transmitter having a current coverage beam.

The terminal receives 10 a communication signal from the current transmitter. The terminal also receives 12 communication signals from adjacent service transmitters having respective adjacent coverage beams. The terminal detects 14 signal-to-noise ratios (SNRs) of the current coverage beam and the adjacent coverage beams communicating respective signals from the current and adjacent service transmitters. The detection can be by way of probe cycles probing the satellites for SNR data. The SNR detection can also be by measuring power of received signals by receiving data in downlink probe responses. The terminal can send 10 a probe message at the beginning of the probe cycle to the current service transmitter and receive a downlink response indicating the SNR of the terminal. The terminal can send 12 probe messages at every probe cycle to the adjacent service transmitters and receive downlink responses indicating the SNR of the terminal. Alternatively, the terminal can detect 14 SNRs of variously broadcasted downlink messages from all of the transmitters. In either way, the terminal detects by measurement transmitters SNRs or downlink data of SNRs for the terminal.

The terminal filters 16 the SNRs from the current and adjacent coverage beams into filtered estimates, with each transmitter having a plurality of filtered estimates. The terminal selects 18 one of the adjacent service transmitter as a selected service transmitter having a selected coverage beam by determining which one of the adjacent coverage beams has a maximum difference D(k) between the maximum filter estimates of the adjacent coverage beams and the maximum filter estimate of the current coverage beam. As such, the terminal has selected one of the adjacent service transmitters having an adjacent coverage beam as the selected service transmitter having the selected coverage beam.

The terminal determines 22 when the maximum difference D(k) is above a predetermined threshold value h, and if so, sends a handover command to the current service transmitter. The terminal receives 24 a control message from the current service transmitter with the control message containing link data of the selected service transmitter. The link data contains communication parameters for establishing communications with the selected service transmitter. The terminal terminates 26 communication with the current service transmitter. The terminal initiates 28 communication with the selected service transmitter by communicating the communication parameters from the selected coverage beam for activating communications with the selected service transmitter. The handover method can be repeated, for example, every predetermined amount of time, so as to provide monitoring of SNRs of the current and adjacent beams for determining when the handover to an adjacent service transmitter should be had so as to maintain the best communications with one of the service transmitters.

As the terminal moves relative to the service transmitters, or as communication conditions change, the SNRs of the current, selected, and adjacent beam will change over time. As the SNR of an adjacent coverage beam approaches the SNR of the current coverage beam, the handover method detects 14, filters 16 the SNRs, determines 18 the maximum filtered estimates 20, and determines 22 the maximum difference D(k) for selecting the selected service transmitters, when the maximum difference D(k) exceeds that threshold, as a monitoring process. The monitoring process is typically a probe cycle of process steps 14-22. The proble cycles can be executed on a repeating time schedule, such as once every second.

When the maximum difference exceeds 22 the threshold value, then the terminal initiates a hand off process in steps 24 through 30. The terminal sends 24 a hand over command to the current service transmitter. The terminal receives 26 a control message from the current service transmitter. The control message contains link data including communication parameters associated with the selected service transmitter. The terminal terminates 28 communications with the current service transmitter. The terminal then initiates 30 communication with the selected service transmitter using the communication parameters. When the hand over process of steps 24 through 30 are complete, the selected service transmitter becomes the current transmitter and the current transmitters becomes an adjacent service transmitter. The terminal can then execute repetitively additional probe cycles 10-22 in anticipation of another hand over process 24-30.

The handover process consists of a number of different subprocesses, namely, the handover process flows from a handover decision 22, a handover request 24, handover allocation and granted step 26, and a handover execution 30 for a terminal initiated handover method. The handover method makes a handover decision by monitoring SNRs, or equivalently power measurements of the service beams to identify when a predetermined threshold is met for initiating the handover process 24-30 to an adjacent service transmitter that is the selected service transmitter. The function of handover request 24 is to send a handover request to the current service transmitter, which may be a satellite payload, when the handover decision 22 criterion is met. The satellite payload allocates resources, such as physical channel and network resources, and sends handover granted message 26 and resource information to the requesting terminal. The handover process 24 through 30 is completed when the requesting terminal receives newly assigned resources indicated in link data and switches to the new channel of the selected service transmitter and new antenna service coverage beam of the selected service transmitter that becomes the new current service transmitter. If there are no resources available on the satellite payload of the selected service transmitter, then the terminal will continue sending handover request messages to the satellite payload of the current service serving beam 28 or receives 26 a handover granted message from the payload.

Assumptions are made regarding the terminal initiated handover process. The terminal contains information indicating the current serving coverage uplink beam and its neighboring adjacent coverage beams. The terminal sends the uplink command to the current serving coverage beam as well as all neighboring adjacent coverage beams using either the serial or parallel methods of communications during the probe cycle 10 through 22. The commands can be in either in-band or out-of-band command signals. The probe commands can be periodic, aperiodic, or on-demand. Step 10 can be used to receive response messages from communicated probing commands of all in-view transmitters for receiving reply messages for the purpose of detecting the SNRs of all of the transmitters in view and for the purpose of determining status of the in-view transmitters. Terminals can send uplink probe commands to the payloads at every uplink probe cycle at the start of step 10. The payload estimates received SNRs in the current serving beam as well as in neighboring adjacent coverage beams using received uplink probes 12. Measured SNRs at the payload are sent to the terminal every probe cycle. The terminal keeps a history of received SNRs for the current serving beam and neighboring beams. The terminal uses an Exponentially Weighted Moving Average (EWMA) filter of length N to filter the instantaneous SNR.

The terminal handover process can be a model using mathematical expressions. The term k is a current probe cycle number count, which increments by one for each elapsed probe cycle period. The term S_{c}(x) is a payload estimate of the probe SNR for probe cycle number x in the terminal current beam. The term Y={y|y is a neighboring beam number to which the terminal sends mobility probes, excluding the current beam. The set Y will differ, depending upon the terminal location. The cardinality of Y is J. The term J can change over time, depending on the location of the terminal. The term Sₙ(x,y) is the payload estimate of the probe SNR for probe cycle number x in neighboring beam number y. The term Ŝ_{c}(x) is the terminal SNR estimate for the current beam during probe cycle number x. The term Ŝₙ(x,y) is the terminal SNR estimate for neighboring beam y during probe cycle number x. The term D(x) is the difference between the current beam terminal SNR estimate and the highest neighboring beam terminal SNR estimate during probe cycle number x. The term α is the forgetting factor used in the calculation of Ŝ_{c}(x) and Ŝₙ(x,y). Alpha ranges from 0 to 1. The term N is the filter length used in the calculation of Ŝ_{c}(x) and Ŝₙ(x,y). The term W is the total weight value used in the calculation of Ŝ_{c}(x) and Ŝₙ(x,y). The term h is the hysteresis value used in the terminal beam handover decision. The total weight value W is calculated as W=Σᵢ₌₁ⁿα^{N-i}. The terminal SNR estimate for the current beam is calculated by Ŝ_{c}(k)=W⁻¹Σᵢ₌₁ⁿα^{N-i}S_{c}(k−N+i).

The terminal SNR estimates for the neighbor beams are calculated by Ŝₙ(k,y)=W⁻¹Σᵢ₌₁ⁿα^{N-i}Sₙ(k−N+i,y). For each probe cycle, the difference between the current beam terminal SNR estimate and the highest neighboring beam terminal SNR estimate is calculated by

$$D ( k ) = {max}_{y ∈ Y} \{ {\hat{S}}_{n} ( k , y ) \} - {\hat{S}}_{c} ( k ) and {y}^{*} = arg \{ {max}_{y ∈ Y} ( {\hat{S}}_{n} ( k , y ) ) . \}$$

For each probe cycle, the terminal determines whether to retain the current coverage beam or to initiate a beam handover request. If the maximum difference is D(k)≦h, then the terminal retains the current coverage beam selection. If maximum difference D(k)>h, then terminal initiates a beam handover request to the neighboring beam number y*.

In general, a larger forgetting factor implies less sensitivity to sample-to-sample SNR variation, but the handover decision may heavily rely on past history. A larger h will reduce toggling, but it will increase handover latency. N, h, and α are chosen to minimize overall root-mean-square (RMS) estimation error and handover toggling, subject to the constraint of terminal dynamics. The smoothing effect of the exponential weighted moving average filter provides a smoothing effect upon the received instantaneous SNR measurement S_{c}(x) from the satellite payload where the instantaneous received SNRs are substantially reduced in the estimated filtered SNRs, as expressed in db. The terminal can receive SNR estimates for the current coverage beam and an adjacent coverage during a probe cycle of number x. Delay handover effects occur by introducing toggling reduction parameter h.

The present invention has specific applications to terminal initiated handover for intrasatellite transmitter antenna handover including any space-related vehicle such as high altitude aircraft or balloon. The method is a handover protocol that is designed to provide intrasatellite, or any space-related vehicle, such as high altitude aircraft or balloon, multibeam antenna, or multiple antennas, handover detection and decision. The handover protocol consists of a SNR estimator preferably based on forgetting factors for SNR monitoring. A threshold delay is introduced to ensure the reliability of handover decision to prevent undesirable handovers during beam switching. The method applies to both uplink and downlink handovers. Uplink and the downlink multibeam antenna patterns can be the same or different. Those skilled in the art can make enhancements, improvements, and modifications to the invention, and these enhancements, improvements, and modifications may nonetheless fall within the spirit and scope of the following claims.

What is claimed is:

1. A handover method for handing off communications from a current service transmitter having a current coverage beam to a selected service transmitter having a selected coverage beam, the selected service transmitter being one of one or more adjacent service transmitters having respective adjacent coverage beams, the handover method being executed in a mobile terminal, the handover method comprising the steps of,
receiving a current signal through current coverage beam,
receiving adjacent signals through adjacent coverage beams,
detect signal to noise (SNR) ratios of all of the received signals,
determine estimates of the SNR ratios of the current signal and the adjacent signals, the estimates are filtered estimates of the SNR ratios,
select a maximum difference between the estimates for the current signal and the estimates for the adjacent signals for selecting a selected signal of one of the adjacent signals of a respective selected adjacent beam of one of the adjacent coverage beams,
send a command to a current servicing transmitter currently transmitting the current service beam for indicating a communication data link through the selected adjacent beam of the selected adjacent beam of a selected adjacent servicing transmitter when the difference between the estimates of the current signal and the selected signal is greater than a predetermined threshold,
receive a control message from the current servicing transmitter indicating the communication link with the selected adjacent servicing transmitter, and
initiate communications with the selected adjacent service beam of the selected adjacent servicing transmitter for handing off communications of the receiver from the current service beam of the current servicing transmitter to the selected adjacent beam of the selected adjacent servicing transmitter.

2. The method of claim 1 wherein, detection step comprises the steps of
sending probe commands to the current service transmitter and adjacent service transmitters, and
receiving probe responses containing data indicating the SNR of the terminal.

3. The method of claim 1 wherein,
the filter estimates are determined by an unbiased weighted average.

4. The method of claim 1 wherein, the initiate steps comprises the step of,
communicating communication parameters to the selected adjacent transmitter,

5. The method of claim 1 wherein,
the threshold is an h threshold value equal to predetermined value.

6. The method of claim 1 wherein,
the threshold is an h threshold value equal, the h threshold determines a handover delay time.

7. The method of claim 1 wherein the detect step comprises the steps of,
sending a probe message to the current and adjacent transmitters, and
receiving messages from the current and adjacent transmitters indicating the SNR from the mobile terminal
